(19) United States
(12) Patent Application Publication
(10) Pub. No.: US 2008/0193101 A1
(43) Pub. Date: Aug. 14, 2008

(54) Synthesis of Composite News Stories

(75) Inventors: Lalitha Agnihotri, Tarrytown, NY (US); Nevenka Dimitrova, Pelham Manor, NY (US); Mauro Barbieri, Eindhoven (NL); Alan Hanjalic, Delft (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,653

(22) PCT Filed: Mar. 29, 2006
(86) PCT No.: PCT/IB06/50956

§ 371 Date: Sep. 25, 2007

Related U.S. Application Data
(60) Provisional application No. 60/666,919, filed on Mar. 31, 2005.
(60) Provisional application No. 60/701,527, filed on Jul. 21, 2005.

(51) Int. Cl. G11B 27/00

(52) U.S. Cl. 386/52

(57) ABSTRACT

A method and system characterizes (220) individual news stories and identifies (230) a common news story among a variety of stories based on this characterization. A composite story is created (240-280) for the common news story, preferably using a structure that is based on a common structure of the different versions of the story. The selection of video segments (110) from the different versions of the story for inclusion in the composite story is based on determined rankings (260, 270) of the video and audio content of the video segments (110).

This invention relates to the field of video image processing, and in particular to a system and method for analyzing video news stories from a variety of sources to identify a common story and to create a composite video of the story from the various sources.

Different news sources often present the same news story from different perspectives. These different perspectives may be based on different political views, or other factors. For example, the same event may be presented favorably by one source, and unfavorably by another, depending upon whether the outcome of the event was favorable or unfavorable to a given political entity. Similarly, the particular aspects of an event that are presented may differ between a science based news source and a general-interest based news source. In like manner, the same story may be presented differently from the same source, depending, for example, if the story is being presented during the “entertainment news” segment of a news show or the “financial news” segment.

Methods and systems are available for distinguishing individual news stories, identifying and categorizing the stories, and filtering the stories for presentation to a user based on the user's preferences. However, each presentation of the story is generally a playback of the recorded story, as it was received, with its own particular perspective.

Finding multiple presentations of the same story can be a time consuming process. If the user uses a conventional system to access multiple sources to find stories based on the user's general preferences, the results will typically be a ‘flood’ of a mix of stories from all of the sources. When the user finds a story of particular interest, the user identifies key words or phrases associated with the story, then submits another search for news stories from the variety of sources using the key words or phrases of the story of interest. Because of the mix of stories from all the sources, the user may have difficulty filtering through all of the choices to distinguish a story of interest from stories of non-interest, particularly if it is not clear which of the available choices are merely choices of the same story (of non-interest) from different sources. Additionally, depending upon the skill of the user and/or the quality of the search engine, the search based on user-defined key words and phrases may result in an over-filtering or under-filtering of the available stories, such that the user may not be presented some perspectives that would have been desired, or may be presented with different stories that merely matched the selected key words or phrases.

It is an object of this invention to provide a method and system that efficiently identifies a common story among a variety of story sources. It is a further object of this invention to synthesize a composite news story from different versions of the same story. It is a further object of this invention to efficiently structure the composite news story for ease of comprehension.

These objects and other are achieved by a method and system that characterizes individual news stories and identifies a common news story among a variety of stories based on this characterization. A composite story is created for the common news story, preferably using a structure that is based on a common structure of the different versions of the story. The selection of segments from the different versions of the story for inclusion in the composite story is based on determined rankings of the video and audio content of the segments.

The invention is explained in further detail, and by way of example, with reference to the accompanying drawings wherein:

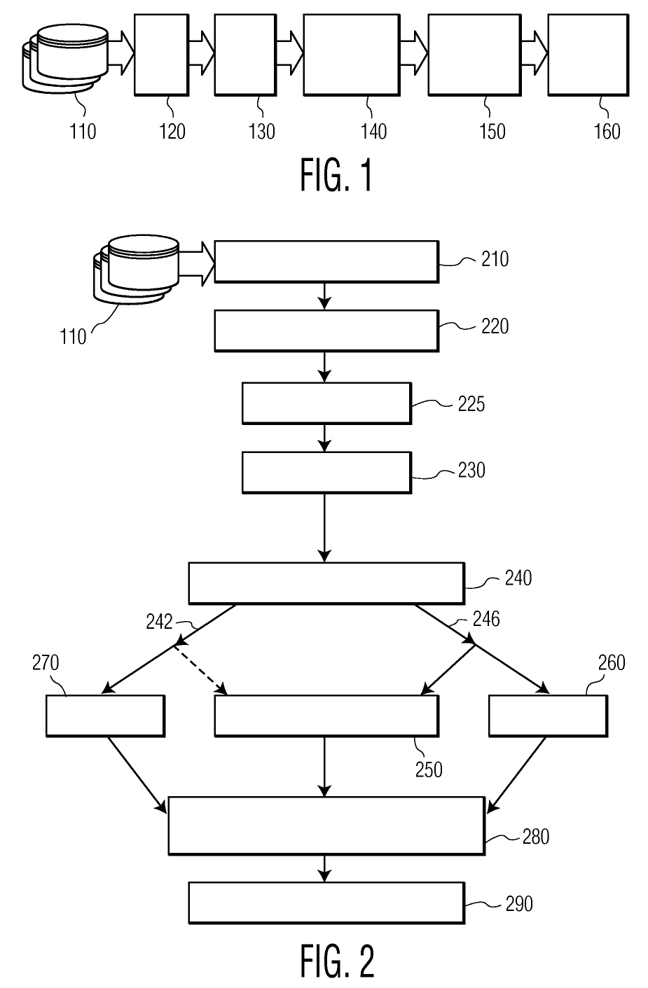

FIG. 1 illustrates an example block diagram of a story synthesis system in accordance with this invention.

FIG. 2 illustrates an example flow diagram of a story synthesis system in accordance with this invention.

Throughout the drawings, the same reference numeral refers to the same element, or an element that performs substantially the same function. The drawings are included for illustrative purposes and are not intended to limit the scope of the invention.

FIG. 1 illustrates a block diagram of a story synthesizer system in accordance with this invention. A plurality of video segments 110 are accessed by a reader 120. In a typical embodiment of this invention, the video segments 110 correspond to recorded news clips. Alternatively, the segments 110 may be located on a disc drive that contains a continuous video recording, such as a “TiVo” recording, from which individual video segments 110 can be distinguished, using techniques common in the art. The video segments 110 may also be stored in a distributed memory system or database that extends across multiple devices. For example, some or all of the segments 110 may be located on Internet sites, and the reader 120 includes Internet-access capabilities. Generally, the video segments 110 include both images and sound, which for ease of reference are termed video content and audio content, although, depending upon the content, some video segments 110 may contain only images, or only sound. The term video segment 110 is used herein in the general sense, to include either images or sound, or both.

A characterizer 130 is configured to analyze the video segments 110 to characterize each segment, and, optionally, sub-segments within each segment. The characterization includes the creation of representative terms for the story segment, including such items as: date, news source, topic, names, places, organizations, keywords, names/titles of speakers, and so on. Additionally, the characterization may include a characterization of the visual content, such as histograms of colors, positions of shapes, types of scenes, and so on, and/or a characterization of the audio content, such as whether the audio includes speech, silence, music, noise, and so on.

A comparator 140 is configured to identify segments 110 that correspond to different versions of the same story, based on the characterization of each segment 110. For example, segments 110 from different news sources that contain a common scene, and/or reference a common place name, and/or include common key words or phrases, and so on, will likely be segments 110 that relate to a common story, and will be identified as a set of story-segments. Because segments 110 may be associated with multiple stories, the inclusion of a segment 110 in a set related to one story does not preclude its inclusion in a set related to another story.

A composer 150 is configured to organize the set of segments related to each story to form a presentation of the story that is reflective of the various segments. The capabilities and features of the composer 150 will be dependent upon the particular embodiment of this invention.

In a straightforward embodiment of this invention, the composer 150 creates an identifier of the story, using, for example, a caption derived from one or more of the segments in the set, and an index that facilitates access to the segments in the set. Preferably, such an index is formed using links to the segments 110, so that a user can easily “click and view” each segment.

In a more comprehensive embodiment of this invention, the composer 150 is configured to create a composite video from the segments 110 of the set, as detailed further below. Typically, segments of a news story from a variety of sources exhibit not only common content, but also a common structure for the presentation of the material in the segment 110, from an introduction of the story, to a presentation of more detailed scenes, to a wrap-up of the story. A mere concatenation of the segments 110 from the varied sources will result in a repetition of each “introduction:reportage scenes:wrap-up” sequence from each source, and such a structure-repetition may be disjoint, and may lack cohesiveness. In a preferred embodiment of this aspect of the invention, the composer 150 is configured to select and organize segments 110 from the set so as to form a composite video that conforms to the general structure of the source material. That is, using the above example structure, the composite video will include an introduction, followed by detailed scenes, followed by a wrap-up. Each of the three structural sections (introduction, scenes, wrap-up) will be based on the corresponding sub-sections of the variety of sections 110 in the set, as detailed further below.

One of ordinary skill in the art will recognize that the composer 150 may be configured to create a presentation that lies between or beyond the range of features in the example straightforward and comprehensive embodiments discussed above, as well as optional combinations of such features. For example, an embodiment of the composer 150 that creates a cohesive composite may also be configured to provide an indexed-access to the individual segments, either independently or via interaction while the composite is being presented. In like manner, an embodiment of a system wherein the composer 150 merely provides the indexed-access to segments may include a link to a media-player that is configured to sequentially present video from a given list of segments.

A presenter 150 is configured to receive the presentation from the composer 150 and present it to a user. The presenter 150 may be a conventional media playback device, or it may be integrated with the system to facilitate access to the variety of features and options of the system, and particularly the interactive options provided by the composer 150.

The system of FIG. 1 also preferably includes other components and capabilities commonly available to video processing and selection systems, but not illustrated for ease of understanding of the salient aspects of this invention. For example, the system may be configured to manage the selection of sources that provide the segments 110 to the system and/or the system may be configured to manage the presentation of the choices of stories that are presented to the user. In like manner, the system preferably includes one or more filters that are configured to filter the segments or the stories based on preferences of the user, based on the characterizations of the segments and/or a composite characterization of each story.

FIG. 2 illustrates an example flow diagram for a story synthesizing system in accordance with this invention. As noted above, the invention includes a variety of aspects and may be embodied using a variety of features and capabilities. FIG. 2 and the description below are not intended to imply required inclusions, nor expressed exclusions, and are not intended to limit the spirit or scope of this invention.

At 210, video segments 110 associated with stories are identified, using any of a variety of techniques. U.S. Pat. No. 6,363,380, “MULTIMEDIA COMPUTER SYSTEM WITH STORY SEGMENTATION CAPABILITY AND OPERATING PROGRAM THEREFOR INCLUDING FINITE VIDEO PARSER”, issued 26 Mar. 2002 to Nevenka Dimotrova, and incorporated by reference herein, teaches a technique for segmenting continuous video that partitions the video into “video shots”, distinguished by video breaks, or discontinuities, and then groups related shots based on visual and audio content within the shots. Sets of related shots are grouped to form a story segment based on determined sequences of such shots, such as “start:host:guest:host:end”.

At 220, the segments are characterized, using any of a variety of techniques available to identify distinguishing characteristics within a video segment, typically based on visual content (colors, distinctive shapes, number of faces, particular scenes, etc.), audio content (types of sounds, speech, etc.), and other information, such as close-caption text, metadata associated with each segment, and so on. This characterization, or identification of features, may be combined with, or integral to, the identification of story segments in 210. For example, U.S. published patent application 2003/0131362, “A METHOD AND APPARATUS FOR MULTIMODAL STORY SEGMENTATION FOR LINKING MULTIMEDIA CONTENT”, Ser. No. 10/042,891 filed 9 Jan. 2002 for Radu S. Jasinschi and Nevenka Dimitrova, and incorporated by reference herein, teaches a system that partitions a news show into thematically contiguous segments, based on common characteristics, or features, of the content of the segments.

At 225, the segments are optionally filtered, primarily to remove from further consideration, segments that are likely to be of no interest to the current user. This filtering may be integrated with the above story-segmentation 210 and characterization 220 processes, above. U.S. published patent application, “PERSONALIZED NEWS RETRIEVAL SYSTEM”, Ser. No. 10/932,460, a divisional of 09/220,277 filed 23 Dec. 1998 for Jan H. Elenbaas et al., and incorporated by reference herein, teaches a segmenting, characterizing, and filtering system that identifies and presents news stories that may be of interest to a user, based on expressed and implied preferences of a user.

At 230, the characterized and optionally filtered segments are compared to each other, to determine which segments may be related to the same story. Preferably, this matching is based on some or all of the features of the segments determined at 220; of particular note, however, the significance of each of these features in determining whether two segments are related to a common story is likely to differ from the significance of each feature in determining which video shots or sequences form a segment in processes 210 and 220, above.

In a preferred embodiment of this invention, two segments A, B are determined to correspond to the same story if the following match parameter, M, exceeds a given threshold:

$$M {\sum }_{i}^{N} {W}_{i} * {F}_{i} ( {V}_{i}^{A} , {V}_{i}^{B} ) ,$$

where V^{A} is the feature vector of segment A, V^{B} is the feature vector of segment B, Wᵢ is the weight given to each feature i in the vectors. The weight W given to a name feature for identifying a common story, for example, is typically substantially greater than the weight given to a topic feature, because of the strength of names for distinguishing among stories. The comparator function Fᵢ depends upon the particular feature, and, in general, returns a measure of similarity that varies between 0 and 1. For example, a function F that is used for comparing names may return a “1” if the names match, and “0” otherwise; or, a 1.0 if a first and last name match, a 0.9 if a title and last name match, a 0.75 if only the last name matches, and so on. In another example, a function F that is used for comparing histograms of colors may return a mathematically determined measure, such as a normalized dot-product of the histogram vectors.

Determining each set of segments that correspond to a common story is based on combinations of the match parameter M between pairs of segments. In a simple embodiment, all segments that have at least one common match are defined as a set of segments that correspond to a common story. For example, if A matches B, and B matches C, then {A, B, C} is defined as a set of segments of a common story, regardless of whether A matches C. In a restrictive embodiment, a set may be defined as only those segments wherein each segment matches each and every other segment. That is, {A, B, C} defines a set if and only if A matches B, B matches C, and C matches A. Other embodiments may use different set-defining-rules. For example, if A matches B and B matches C, C can be defined as being included in the set if the match parameter between A and C exceeds at least some second, lower threshold. In like manner, a dynamic thresholding rule can be used, wherein initially the set-defining rule is lax, but if the resultant set is too large, the parameters of the set-defining rule, or the match-threshold level, or both, can be made more stringent. These and other techniques for forming sets based on two-way comparisons are common in the art.

Alternatively, other techniques can be used to find segments having common features, including, but not limited to clustering techniques and others, as well as trainable systems, such as neural networks and the like.

As noted above, upon defining each set of segments corresponding to a common story, an identification of the story and an index to the segments can be provided as an output of this invention. Preferably, however, a system of this invention also includes the synthesis of a composite video, as illustrated in processes 240-290 of FIG. 2.

At 240, the segments corresponding to a single story are partitioned, or re-partitioned, into sub-segments for further processing. The sub-segments include both audio sub-segments 242 and video sub-segments 246. These sub-segments are preferably complete in and of themselves, so that the resultant composite video formed by a combination of such sub-segments will not exhibit major discontinuities, such as half-sentences, incomplete shots, and so on. Generally, the breaks between video sub-segments will coincide with breaks in the original video source, and the breaks between audio sub-segments will coincide with natural language breaks. In a preferred embodiment, a determination is made as to whether the audio portion of a segment corresponds directly with the video imagery, or whether it's a non-associated sound, such as a ‘voice over’. If the audio and video are directly related, common break points are defined for the audio 242 and video 246 sub-segments.

At 250, the structure of the original segments is analyzed to determine a preferred structure for presenting the composite story. This determination is primarily based on the structure that can be deduced from the video sub-sections 246, however the structure of the audio sub-sections 242 may also affect this determination. As noted above, U.S. Pat. No. 6,363,380 addresses the modeling of typical presentation structures, such as “start:host:guest:host:end”. A common structure for news stories includes “anchor:reporter:scenes:reporter:anchor”, where the first anchor sub-segment corresponds to the lead-in, or caption, and the final anchor sub-segment corresponds to a wrap-up, or commentary. Similarly, a common structure for financial news includes “anchor:graphics:commentator:scenes:anchor”.

In a typical embodiment of this invention, the structural analysis 250 and segment partitioning 240 will be performed as an integrated process, or an iterative process, because the determination of the overall structure in the structural analysis 250, based on an original video partitioning, can have an affect on the final video and audio partitioning of each segment that is used to create a composite video based on this overall structure.

At 280, select sub-sections are arranged to form a composite video corresponding to the story. The selection of these sub-sections is preferably based on a ranking of the video 246 and audio 242 sub-sections, or a combination of such rankings, or a ranking based on a combination of the video and audio sub-sections.

Any of a variety of techniques may be used to rank the audio 242 and video 246 sub-sections at 270, 260. In a preferred embodiment of this invention, the ranking of each takes the form of:

$${R}_{i} = I ( i ) * {\sum }_{j} {W}_{j} * {R}_{ij} / {\sum }_{j} {W}_{j}$$

where I(i) is the intrinsic importance of the audio or video content of the sub-section i, based on, for example, the text, graphics, face, and other items in the video, and the occurrence of names, places, and other items in the audio. Each of the “j” ranking terms Rᵢⱼ are based on different audio or video measures for ranking the sub-sections. For example, in ranking video sub-sections, one of the rankings can be based on the objects that appear in the video sub-section, while another ranking can be based on visual similarity, such as the general color scheme of the frames in the video sub-section. Similarly, in ranking audio sub-sections, one of the rankings may be based on words occurring in the audio sub-section, while another ranking may be based on audio similarity, such as sentences spoken by the same person. Other ranking schemes will be evident to one of ordinary skill in the art in view of this disclosure. The Wⱼ term corresponds to the weight given to each ranking scheme.

To facilitate the ranking of each sub-section, the segments are clustered, using for example a k-means clustering algorithm. In each cluster are a number of segments; the total number of segments in a cluster provides an indication of the importance of the cluster. The rank of a sub-section is thereafter based upon the importance of the cluster within which segments of the sub-section occur.

As noted above, the sub-sections are selected and organized for presentation based on the determined preferred structure of the composite video. Generally, only one of the sub-segments corresponding to an introduction to the story will be selected for inclusion, and this selection is preferably based on the ranking of the audio content of the sub-sections corresponding to introductions in the original sections. Thereafter, the “detailed” portions of the structure are generally based on the ranking of the video content of the sub-segments, although highly rated audio sub-segments may also affect the selection process. If the audio and video sub-sections are identified as being directly related, as discussed above, a selection of one preferably effects the selection of the other, so that the sub-sections are presented coherently.

The composite video from 280 is presented to the user at 290. This presentation may include interaction capabilities, as well as features that enhance or guide the interaction. For example, if one particular aspect or event in the story is determined to be particularly significant, based on its coverage from a variety of sources, an indication of this significance may be presented while the corresponding sub-sections are being rendered, with interactive access to other audio or video sub-segments related to this significant aspect or event.

The foregoing merely illustrates the principles of the invention. It will thus be appreciated that those skilled in the art will be able to devise various arrangements which, although not explicitly described or shown herein, embody the principles of the invention and are thus within its spirit and scope. For example, this invention is presented within the context of viewing different versions of the same news story. One of ordinary skill in the art will recognize that this news-related application can be integrated with, or provided access to, other information-access related applications. For example, in addition to being able to access other segments 110 related to a current story, the presenter 290 may be configured to also access other information sources related to the current story, such as Internet sites that can provide background information based on the characteristic features of the story, and so on. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. A system comprising:
a reader (120) that is configured to provide access to a plurality of video segments (110),
a characterizer (130), operably coupled to the reader (120), that is configured to characterize each segment of the plurality of video segments (110),
a comparator (140), operably coupled to the characterizer (130), that is configured to compare the characteristics of each segment to identify a plurality of versions of a common story.

2. The system of claim 1, further including
a presenter (160), operably coupled to the comparator (140) and the reader (120), that is configured to provide a presentation based on the plurality of versions of the common story.

3. The system of claim 2, further including
a composer (150), operably coupled to the comparator (140) and the reader (120), that is configured to create the presentation, based on content of the video segments (110) of the plurality of versions.

4. The system of claim 3, wherein
the composer (150) is configured to rank (260, 270) the content of the video segments (110) based on video and audio content of the video segments (110).

5. The system of claim 3, wherein
the composer (150) is configured to:
determine (250) a common structure, based on one or more structures of the content of the video segments (110) of the plurality of versions, and
create (280) the presentation based on the common structure.

6. The system of claim 5, wherein
the composer (150) is further configured to select (280) one or more of the video segments (110) for inclusion in the presentation, based on one or more rankings of at least one of video content and audio content of the video segments (110).

7. The system of claim 1, wherein
the comparator (140) includes a filter (225) that is configured to facilitate identification of the plurality of versions of the common story based on one or more preferences of a user.

8. A method comprising:
characterizing (220) each segment of a plurality of video segments (110) to create a plurality of segment characterizations,
comparing (230) the segment characterizations to each other to identify a plurality of versions of a common story.

9. The method of claim 8, further including
creating (240-280) a presentation based on the plurality of versions of the common story.

10. The method of claim 9, wherein
the presentation is based on content of the video segments (110) of the plurality of versions.

11. The method of claim 9, wherein
creating (240-280) the presentation includes ranking (260, 270) the content of the video segments (110) based on video and audio content of the video segments (110).

12. The method of claim 9, wherein
creating (240-280) the presentation includes:
determining (250) a common structure, based on one or more structures of the content of the video segments (110) of the plurality of versions, and
creating (280) the presentation based on the common structure.

13. The method of claim 9, wherein
creating (240-280) the presentation further includes selecting one or more of the video segments (110) for inclusion in the presentation, based on one or more rankings of at least one of video content and audio content of the video segments (110).

14. The method of claim 8, further including
filtering (225) the video segments (110) based on the segment characterizations and one or more preferences of a user, to facilitate identifying the plurality of versions of the common story.
